(19) United States
(12) Patent Application Publication
(10) Pub. No.: US 2025/0183360 A1
(43) Pub. Date: Jun. 5, 2025

(54) SOLID ELECTROLYTE, SOLID ELECTROLYTE LAYER, AND SOLID ELECTROLYTE BATTERY

(71) Applicant: TDK CORPORATION, Tokyo (JP)

(72) Inventors: Masato KURIHARA, Tokyo (JP); Hisashi SUZUKI, Tokyo (JP); Taisuke HORIKAWA, Tokyo (JP); Takuya AOKI, Tokyo (JP); Hiroyuki YAMADA, Tokyo (JP)

(73) Assignee: TDK CORPORATION, Tokyo (JP)

(21) Appl. No.: 18/846,057

(22) PCT Filed: Mar. 13, 2023
(86) PCT No.: PCT/JP2023/009673

§ 371 Date: Sep. 11, 2024

(30) Foreign Application Priority Data
Mar. 11, 2022 (JP) 2022-038447

(51) Int. Cl. H01M 10/0562

(52) U.S. Cl. CPC H01M 10/0562; H01M 2300/0077; H01M 2300/008

(57) ABSTRACT

A solid electrolyte includes: LiₐA_{b}E_{c}(SO₄)_{d}JₑX_{f}Hₕ, A is selected from alkaline earth metals and alkali metals other than Li, E is selected from Al, Ga, In, Sc, Y, Ti, Zr, Hf, and lanthanides, J is selected from OH, BO₂, BO₃, BO₄, B₃O₆, B₄O₇, CO₃, NO₃, AlO2, SiO₃, SiO₄, Si₂O₇, Si₃O₉, Si₄O₁₁, Si₆O₁₈, PO₃, PO₄, P₂O₇, P₃O₁₀, SO₃, SO₅, S₂O₃, S₂O₄, S₂O₅, S₂O₆, S₂O₇, S₂O₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH═CH—COO, OOC—CH═CH—COO, C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, and O, X is selected from F, Cl, Br, and I, 0.5≤a<6, 0≤b<6,0<c<2,0.1<d≤6.0, 0<e≤6.0, 0<f≤6.1, and 0≤h≤0.2, and a peak is observed at a diffraction angle 2θ=22.3°±1.0° in an X-ray diffraction pattern in which Cu-Kα is used as a line source.

### TECHNICAL FIELD

The present invention relates to a solid electrolyte, a solid electrolyte layer, and a solid electrolyte battery.

Priority is claimed on Japanese Patent Application No. 2022-038447, filed Mar. 11, 2022, the content of which is incorporated herein by reference.

### BACKGROUND ART

In recent years, the development of electronics technology has been remarkable, and portable electronic devices have been made smaller, lighter, thinner, and multifunctional. Accordingly, there is a strong demand for batteries that serve as power sources for electronic devices to be smaller, lighter, thinner, and more reliable, and solid electrolyte batteries that use a solid electrolyte as an electrolyte have been attracting attention. Solid electrolytes such as oxide solid electrolytes, sulfide solid electrolytes, complex hydride solid electrolytes, and halide solid electrolytes are known.

For example, Non-Patent Document 1 describes that Li₃ScCl₆ which is a halide solid electrolyte has an ionic conductivity of 3 mS/cm and a potential window of 0.91 V (V vs. Li/Li⁺) on the reduction side.

### Citation List

### Non-Patent Document

[Non-Patent Document 1] Jianwen Liang et al., Journal of American Chemical Society 2020, 142, 7012-7022

### SUMMARY OF INVENTION

### Technical Problem

Halide solid electrolytes are said to have a higher ionic conductivity than oxide solid electrolytes, sulfide solid electrolytes, complex hydride solid electrolytes, and the like. Although Li₃ScCl₆ described in Non-Patent Document 1 has a high ionic conductivity (3 mS/cm), it is subject to various limitations, and the properties described in Non-Patent Document 1 may not be expressed as they are or other substances may have to be selected. Therefore, a configuration that can relatively improve ionic conductivity in solid electrolytes with similar structures is required.

The present invention has been made in consideration of the above-described problems, and an object of the present invention is to provide a solid electrolyte, a solid electrolyte layer, and a solid electrolyte battery capable of improving ionic conductivity.

### Solution to Problem

The present invention provides the following means to solve the above-described problems.
(1) A solid electrolyte according to a first aspect includes LiₐA_{b}E_{c}(SO₄)_{d}JₑX_{f}Hₙ . . . (1). In Formula (1), A is at least one element selected from alkaline earth metals and alkali metals other than Li, E is at least one element selected from the group consisting of Al, Ga, In, Sc, Y, Ti, Zr, Hf, and lanthanides, J is at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₅, S₂O₃, S₂O₄, S₂O₅, S₂O₆, S₂O₇, S₂₀₈, BF₄, PF₆, BOB, (COO)₂, N, AlCl₄, CF₃SO₃, CH₃COO, CF₃COO, OOC—(CH₂)₂—COO, OOC—CH₂—COO, OOC—CH(OH)—CH(OH)—COO, OOC—CH(OH)—CH₂—COO, C₆H₅SO₃, OOC—CH—CH—COO, OOC—CH═CH—COO, C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, and O, and X is at least one element selected from the group consisting of F, Cl, Br, and I. In addition, in Formula (1), 0.5≤a<6, 0≤b<6, 0<c<2, 0.1<d≤ 6.0, 0<e≤6.0, 0<f≤6.1, and 0≤h≤0.2 are satisfied. In addition, in the solid electrolyte according to the first aspect, a peak is observed at a diffraction angle 2θ=22.3°±1.0° in an X-ray diffraction pattern in which Cu-Kα is used as a line source.
(2) In the solid electrolyte according to the above-described aspect, a peak may be observed at a diffraction angle 2θ=36.4°±1.0° in the X-ray diffraction pattern in which Cu-Kα is used as a line source.
(3) In the solid electrolyte according to the above-described aspect, in X-ray photoelectron spectroscopy measurement, a peak may be observed at 170±0.5 eV and 532±0.5 eV.
(4) In the solid electrolyte according to the above-described aspect, an ionic conductivity at 25° C. may be 1 mS/cm or more.
(5) A solid electrolyte layer according to a second aspect includes: the solid electrolyte according to the above-described aspect.
(6) A solid electrolyte battery according to a third aspect includes: a negative electrode; a positive electrode; and a solid electrolyte layer that is between the negative electrode and the positive electrode and contains a solid electrolyte. At least one or more of the negative electrode, the positive electrode, and the solid electrolyte layer contains the solid electrolyte according to the above-described aspect.
(7) A solid electrolyte battery according to a fourth aspect includes: a negative electrode; a positive electrode; and the solid electrolyte layer according to the above-described aspect between the negative electrode and the positive electrode.

### Advantageous Effects of Invention

The solid electrolyte according to the above-described aspect can improve ionic conductivity.

### BRIEF DESCRIPTION OF DRAWINGS

FIG. 1 shows X-ray diffraction results of a solid electrolyte according to the present embodiment.

FIG. 2 shows X-ray diffraction results of the solid electrolyte containing a compound of Formula (1).

FIG. 3A is a graph showing X-ray photoelectron spectroscopy measurement results of the solid electrolyte according to the present embodiment, in which a range where an O1s-derived peak occurs is enlarged.

FIG. 3B is a graph showing X-ray photoelectron spectroscopy measurement results of the solid electrolyte according to the present embodiment, in which a range where an S2p-derived peak occurs is enlarged.

FIG. 4 is a cross-sectional schematic view of a solid electrolyte battery 100 according to the present embodiment.

FIG. 5 shows X-ray diffraction results of Comparative Example 4.

FIG. 6 shows charge/discharge curves of Example 4 and Comparative Examples 3 and 4.

### DESCRIPTION OF EMBODIMENTS

Hereinafter, the present embodiment will be described in detail with reference to the accompanying drawing as appropriate. In the drawings used in the following description, a part that becomes a feature of the present invention is sometimes enlarged for convenience in order to allow the feature to be easily understood, and the dimensional ratios of each constituent element and the like are sometimes different from the actual ones. The materials, dimensions, and the like exemplified in the following description are merely examples, and the present invention is not limited thereto and can be implemented by being appropriately modified within a range that does not change the gist thereof.

### “Solid Electrolyte”

A solid electrolyte is a material that can transfer ions by applying an electric field from outside. A high ionic conductivity of a solid electrolyte facilitates smooth exchange of ions in a solid electrolyte battery, resulting in lower internal resistance.

A solid electrolyte contains a halide solid electrolyte represented by LiₐA_{b}E_{c}(SO₄)_{d}JₑX_{f}Hₕ . . . (1). The solid electrolyte may contain a material resulting from a raw material powder as well as the compound represented by Formula (1) above. The material resulting from a raw material powder is, for example, Li₂SO₄.

The solid electrolyte may be in the form of a powder (particles) or in the form of a sintered body obtained by sintering a powder. In addition, the solid electrolyte may also be a molded body obtained by compressing and molding a powder, a molded body obtained by molding a mixture of a powder and a binder, and a coating film obtained by applying a coating material containing a powder, a binder, and a solvent, followed by heating the coating material to remove the solvent. In addition, the main structure of the solid electrolyte may be amorphous or crystalline.

In Formula (1), Li is a lithium ion. a satisfies 0.5≤a<6, preferably satisfies 2.0≤a≤4.0, and more preferably satisfies 2.5≤a≤3.5. When E is Zr or Hf, a is preferably 1.0≤a≤3.0 and more preferably 1.5≤a≤2.5. In the compound represented by Formula (1), if a is 0.5≤a<6, the Li content in the compound is appropriate and the ionic conductivity of a solid electrolyte layer 10 is high.

In Formula (1), A is at least one element selected from alkaline earth metals and alkali metals other than Li. A substitutes for a part of the Li ions. A is, for example, Na or Ca. When A is Na or Ca, a potential window on the reduction side of the solid electrolyte is wider. b satisfies 0≤0<6. In addition, a+b satisfies 0.5≤a+b<6.

In Formula (1), E is an essential component and at least one element selected from the group consisting of Al, Ga, In, Sc, Y, Ti, Zr, Hf, and lanthanides (La, Ce, Pr, Nd, Pm, Sm, Eu, Gd, Tb, Dy, Ho, Er, Tm, Yb, and Lu). E preferably includes Al, Sc, Y, Zr, Hf, and La and more preferably includes Zr and Y. E improves the ionic conductivity of the solid electrolyte. C is 0<b<2. Since the effect of incorporating E is in that case more effective, c is preferably 0.6≤c. In addition, E is also an element that forms a framework of the solid electrolyte. c is more preferably c≤1.

In Formula (1), SO₄ is sulfate. d satisfies 0.1<d≤6.0, preferably satisfies 0.2≤d≤4.0, and more preferably satisfies 0.4≤d≤2.5. When the solid electrolyte contains sulfate, the potential window on the reduction side of the solid electrolyte is wider and unlikely to be reduced.

In Formula (1), J is, for example, at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₅, S₂O₃, S₂O₄, S₂O₅, S₂O₆, S₂O₇, S₂₀₈, BF₄, PF₆, bisoxalate borate (BOB), (COO)₂, N, AlCl₄, CF₃SO₃, CH₃COO, CF₃COO, succinate (OOC—(CH₂)₂-COO), malonate (OOC—CH₂—COO), tartrate (OOC—CH(OH)—CH(OH)—COO), malate (OOC—CH(OH)—CH₂—COO), benzenesulfonate (C₆H₅SO₃), fumarate (OOC—CH—CH—COO), maleate (OOC—CH═CH—COO), citrate (C(OH)(CH₂COOH)₂COO), AsO₄, BiO₄, CrO₄, MnO₄, PtF₆, PtCl₆, PtBr₆, PtI₆, SbO₄, SeO₄, TeO₄, HCOO, and O. J is preferably at least one group selected from the group consisting of OH, SO₄, CH₃COO, CF₃COO, HCOO, and O. J substitutes for a part of sulfate.

e satisfies 0≤e≤6. e is preferably 0.5≤e because the effect of a wider potential window on the reduction side due to inclusion of J is more significant. e is preferably e≤3 so that the ionic conductivity of the solid electrolyte does not decrease due to too high a J content. In addition, d+e satisfies 0.1<d≤6.0.

X is at least one or more element selected from the group consisting of F, Cl, Br, and I. X is preferably at least one or more selected from the group consisting of Cl, Br, and I to increase the ionic conductivity of the solid electrolyte, preferably includes Br and/or I, and particularly preferably includes I. When X includes F, X preferably includes F and two or more selected from the group consisting of Cl, Br, and I because X is a solid electrolyte with a high ionic conductivity.

When X is F, the solid electrolyte has a sufficiently high ionic conductivity and excellent oxidation resistance. When X is Cl, the solid electrolyte has a high ionic conductivity and a good balance between oxidation resistance and reduction resistance. When X is Br, the solid electrolyte has a sufficiently high ionic conductivity and a good balance between oxidation resistance and reduction resistance. When X is I, the solid electrolyte has high ionic conductivity.

f satisfies 0<f≤6.1. d is preferably 1≤f. When f is 1≤d, the strength of a pellet is higher when the solid electrolyte is formed into a pellet shape through pressure molding. In addition, when f is 1≤f, the ionic conductivity of the solid electrolyte is high. In addition, f is preferably f≤5 so that the potential window of the solid electrolyte is not narrowed due to lack of sulfate due to too high an X content.

In Formula (1), His hydrogen. h satisfies 0≤h≤0.2.

Solid electrolytes are, for example, Li₂ZrSO₄Cl₄, Li₃ YSO₄Cl₄, Li₃ScSO₄Cl₄, and Li₃InSO₄Cl₄.

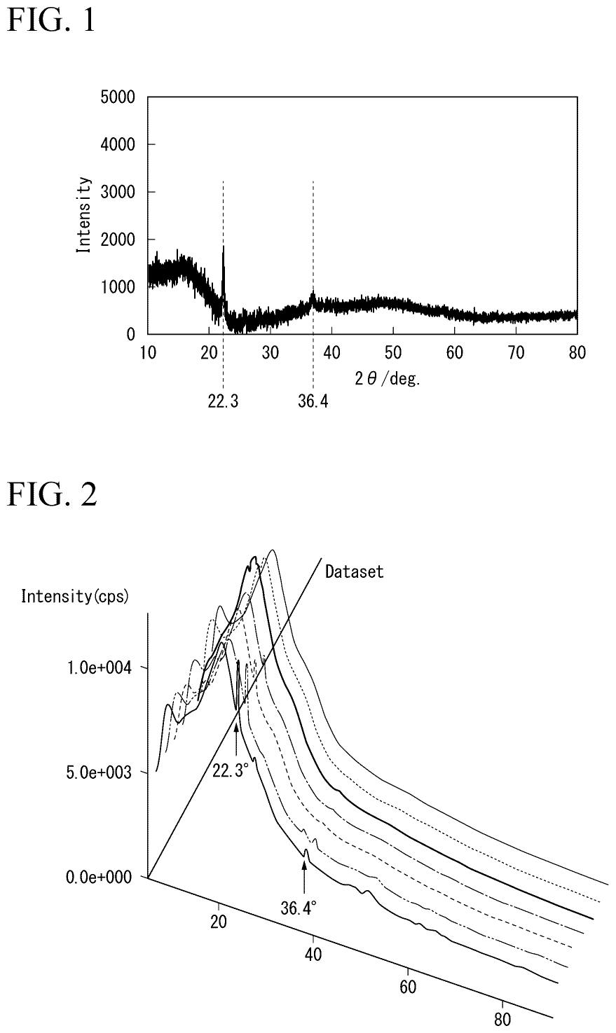

FIG. 1 shows results of X-ray diffraction (XRD) of a solid electrolyte according to the present embodiment. The vertical axis in FIG. 1 is intensity and the horizontal axis is 20. X-ray diffraction is performed using a Cu-α source.

The X-ray diffraction pattern shown in FIG. 1 is one obtained by removing background data of polyimide tape from the measurement results. FIG. 1 shows X-ray diffraction results of Example 4 to be described below. As shown in FIG. 1, in the solid electrolyte according to the present embodiment, a peak is observed at a diffraction angle 2θ=22.3° ±1.0° in an X-ray diffraction pattern in which Cu-Kα is used as a line source. In addition, in the solid electrolyte according to the present embodiment, a peak may be observed at a diffraction angle 2θ=36.4°±1.0° in the X-ray diffraction pattern in which Cu-Kα is used as a line source.

These peaks are thought to be derived from Li₂SO₄ which is a raw material used in production of the compound of Formula (1). The peak occurring at the diffraction angle 2θ=22.3°±1.0° is a first peak that shows the highest intensity in the X-ray diffraction pattern of Li₂SO₄.

The peak occurring at the diffraction angle 2θ=36.4°±1.0° is a peak that shows relatively high intensity in the X-ray diffraction pattern of Li₂SO₄.

These peaks are peaks that disappear when raw materials are allowed to sufficiently react with each other. FIG. 2 shows X-ray diffraction results of the solid electrolyte containing the compound of Formula (1). The X-ray diffraction pattern shown in FIG. 2 is measured raw data from which background data of polyimide tape has not been removed. The further one moves from the front of the paper to the back, the more advanced the reaction between the raw materials. As shown in FIG. 2, the peaks occurring at the diffraction angle 2θ=22.3°±1.0° and the diffraction angle 2θ=36.4°±1.0° disappear as the reaction between the raw materials proceeds. Therefore, the fact that these peaks are observed in the solid electrolyte according to the present embodiment is thought that a part of an unreacted raw material powder (LiSO₄) remains.

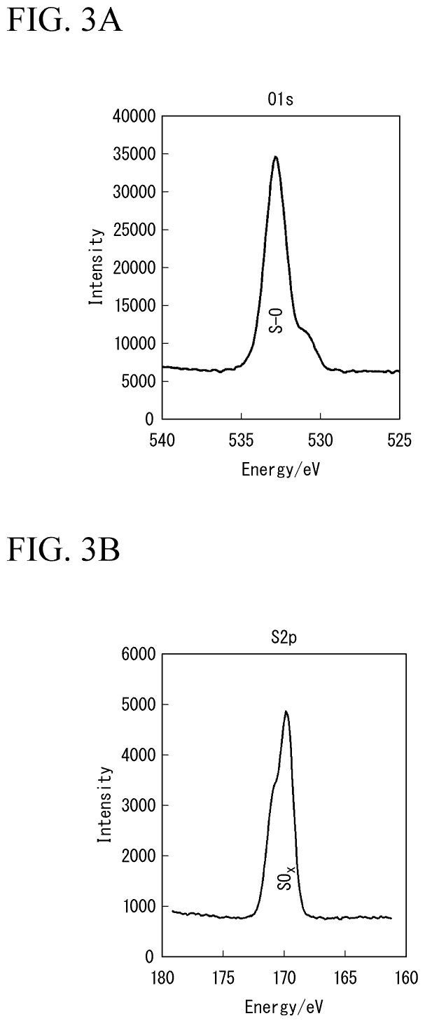

FIGS. 3A and 3B are graphs showing X-ray photoelectron spectroscopy measurement results of the solid electrolyte according to the present embodiment, in which a range where a peak occurs is enlarged. In the solid electrolyte according to the present embodiment, for example, peaks are observed at 170±0.5 eV and 532±0.5 eV. The peak at 170±0.5 eV is an S2p-derived peak of sulfur identified when there is a structure where sulfur is linked to oxygen, and the peak at 532±0.5 eV is an O1s-derived peak of oxygen identified when there is a structure where sulfur is linked to oxygen. In other words, it can be said that the solid electrolyte has a portion with a structure of SO₄, and the structure is thought to be derived from an unreacted raw material powder (LiSO₄).

The solid electrolyte according to the present embodiment has specific peaks observed through X-ray diffraction as described above, it has a high ionic conductivity. For example, the ionic conductivity of the solid electrolyte according to the present embodiment is 1 mS/cm or more. It is not clear why ionic conductivity increases when the solid electrolyte has specific peaks in X-ray diffraction, but it is thought that this is because the remaining crystalline substance LiSO₄ becomes a starting point for forming a microstructure, which has flow paths through which Li ions can be conducted, in the solid electrolyte.

### “Solid Electrolyte Battery”

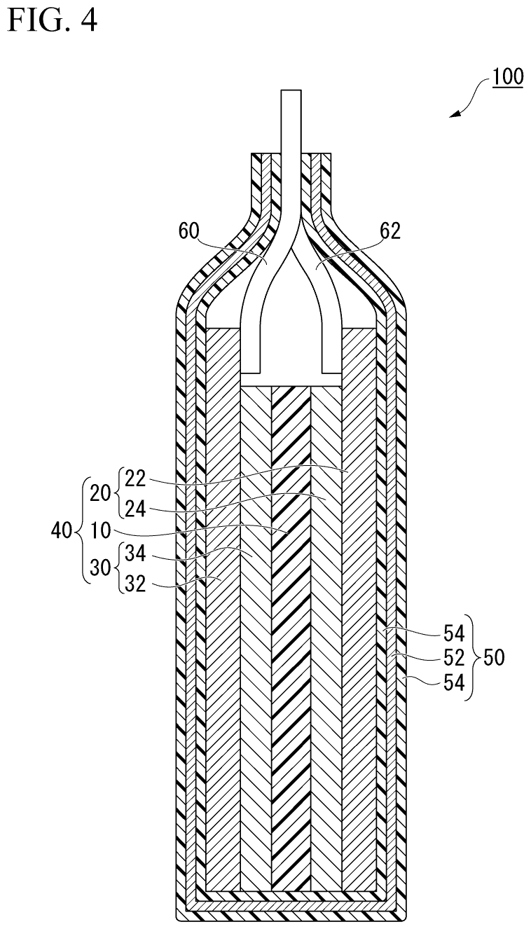

FIG. 4 is a cross-sectional schematic view of a solid electrolyte battery 100 according to the present embodiment. The solid electrolyte battery 100 shown in FIG. 4 includes a power generation element 40 and an exterior body 50. The exterior body 50 covers the periphery of the power generation element 40. The power generation element 40 is connected to outside via a pair of terminals 60 and 62 connected to each other. In FIG. 1, a laminated battery is shown, but a wound battery may also be used. The solid electrolyte battery 100 is used, for example, as a laminate battery, a square battery, a cylindrical battery, a coin type battery, and a button-type battery.

### <Power Generation Element>

The power generation element 40 includes the solid electrolyte layer 10, a positive electrode 20, and a negative electrode 30. The power generation element 40 performs charging or discharging through exchange of ions via the solid electrolyte layer 10 between the positive electrode 20 and the negative electrode 30 and exchange of electrons via an external circuit.

### (Solid Electrolyte Layer)

The solid electrolyte layer 10 is sandwiched between the positive electrode 20 and the negative electrode 30. The solid electrolyte layer 10 contains a solid electrolyte capable of transferring ions by an externally applied voltage. For example, solid electrolytes conduct lithium ions and inhibit transfer of electrons.

The solid electrolyte layer 10 is, for example, a halide solid electrolyte. The solid electrolyte layer 10 contains, for example, the above-described solid electrolyte. If the positive electrode 20 or the negative electrode 30 contains the above-described solid electrolyte, the solid electrolyte contained in the solid electrolyte layer 10 may not be the one described above.

### (Positive Electrode)

As shown in FIG. 4, the positive electrode 20 has a plate-shaped (foil-shaped) positive electrode current collector 22 and a positive electrode mixture layer 24. The positive electrode mixture layer 24 comes into contact with at least one surface of the positive electrode current collector 22.

The positive electrode current collector 22 may be an electron-conductive material that withstands oxidation during charging and is resistant to corrosion. The positive electrode current collector 22 is, for example, a metal such as aluminum, stainless steel, nickel, or titanium, or a conductive resin. The positive electrode current collector 22 may be in powder, foil, punched, or expanded form.

The positive electrode mixture layer 24 contains a positive electrode active material and as necessary, a solid electrolyte, a binder, and a conductive assistant.

The positive electrode active material is not particularly limited as long as it is capable of reversibly progressing lithium-ion occlusion/release and insertion/desorption (intercalation/deintercalation), and positive electrode active materials used in well-known solid electrolyte batteries can be used. Examples of positive electrode active materials include lithium-containing metal oxides and lithium-containing metal phosphorus oxides.

Lithium-containing metal oxides include, for example, lithium cobaltate (LiCoO₂), lithium nickelate (LiNiO₂), lithium manganese spinel (LiMn₂O₄), and composite metal oxides represented by General Formula: LiNiₓCo_{y}Mn₂O₂ (x+y+z=1), lithium vanadium compounds (LiVOPO₄, Li₃ V₂ (PO₄)₃), olivine-type LiMPO₄ (where M indicates at least one selected from Co, Ni, Mn, and Fe), and lithium titanate (Li₄Ti₅O₁₂).

In addition, the positive electrode active material may also be lithium-free. Examples of positive electrode active materials include lithium-free metal oxides (such as MnO₂ and V₂O₅), lithium-free metal sulfides (such as MoS₂), and lithium-free fluorides (such as FeF₃ and VF₃). When using a positive electrode active material that does not contain lithium, a negative electrode is doped with lithium ions in advance, or a negative electrode containing lithium ions is used.

A solid electrolyte contained in the positive electrode 20 is, for example, the solid electrolyte described above. The solid electrolyte contained in the positive electrode 20 may be a halide solid electrolyte other than the solid electrolyte described above.

The amount of a solid electrolyte in the positive electrode mixture layer 24 is not particularly limited, but it is preferably 1 mass % to 50 mass % and more preferably 5 mass % to 30 mass % based on the total mass of a positive electrode active material, the solid electrolyte, a conductive assistant, and a binder.

A binder binds a positive electrode active material, a solid electrolyte, and a conductive assistant together in the positive electrode mixture layer 24, and also firmly bonds the positive electrode mixture layer 24 to the positive electrode current collector 22. The positive electrode mixture layer 24 preferably contains a binder. The binder is preferably oxidation resistant and has favorable adhesiveness.

Examples of binders used in the positive electrode mixture layer 24 include polyvinylidene fluoride (PVDF) or copolymers thereof, polytetrafluoroethylene (PTFE), polyamide (PA), polyimide (PI), polyamideimide (PAI), polybenzimidazole (PBI), polyethersulfone (PES), polyacrylic acid (PA) and copolymers thereof, metal ion cross-linked polyacrylic acid (PA) and copolymers thereof, maleic anhydride-grafted polypropylene (PP), maleic anhydride-grafted polyethylene (PE), and mixtures thereof. Among these, PVDF is particularly preferably used as a binder.

The amount of a binder in the positive electrode mixture layer 24 is not particularly limited, but it is preferably 1 mass % to 15 mass % and more preferably 3 mass % to 5 mass % based on the total mass of a positive electrode active material, a solid electrolyte, a conductive assistant, and the binder. If the amount of binder is too small, it tends not to be possible to form a positive electrode 20 with sufficient adhesive strength. Conversely, too much binder tends to make it difficult to obtain sufficient volume or mass energy density, since common binders are electrochemically inert and do not contribute to discharge capacity.

The conductive assistant improves electron conductivity of the positive electrode mixture layer 24. Well-known binders can be used as the conductive assistant. Conductive assistants are, for example, carbon materials such as carbon black, graphite, carbon nanotubes, and graphene, metals such as aluminum, copper, nickel, stainless steel, iron, and amorphous metals, conductive oxides such as ITO, or mixtures thereof. The conductive assistant may be in powder or fiber form.

The amount of a conductive assistant in the positive electrode mixture layer 24 is not particularly limited. When a conductive assistant is incorporated, the mass proportion of the conductive assistant is preferably 0.5 mass % to 20 mass % and more preferably 1 mass % to 5 mass % based on the total mass of a positive electrode active material, a solid electrolyte, the conductive assistant, and a binder.

### (Negative Electrode)

As shown in FIG. 4, the negative electrode 30 has a negative electrode current collector 32 and a negative electrode mixture layer 34. The negative electrode mixture layer 34 comes into contact with the negative electrode current collector 32.

The negative electrode current collector 32 may have electron conductivity. The negative electrode current collector 32 is, for example, a metal such as copper, aluminum, nickel, stainless steel, or iron, or a conductive resin. The negative electrode current collector 32 may be in powder, foil, punched, or expanded form.

The negative electrode mixture layer34 contains a negative electrode active material and as necessary, a solid electrolyte, a binder, and a conductive assistant.

The negative electrode active material is not particularly limited as long as it is capable of reversibly progressing occlusion and release of lithium ions and insertion and desorption of lithium ions. Negative electrode active materials used in well-known solid electrolyte batteries can be used as the negative electrode active material.

Negative electrode active materials include, for example, carbon materials such as natural graphite, artificial graphite, mesocarbon microbeads, mesocarbon fiber (MCF), cokes, glassy carbon, and a calcined organic compound, metals such as Si, SiOₓ, Sn, and aluminum that can be combined with lithium, alloys of these metals, composite materials of these metals and carbon materials, oxides such as lithium titanate (Li₄Ti₅O₁₂) and SnO₂, and metallic lithium. Natural graphite is preferable as a negative electrode active material.

A solid electrolyte contained in the negative electrode 30 is, for example, the solid electrolyte described above. The solid electrolyte contained in the negative electrode 30 may be a halide solid electrolyte other than the solid electrolyte described above.

A binder and a conductive assistant contained in the negative electrode 30 are the same as the binder and the conductive assistant contained in the positive electrode 20.

### <Exterior Body>

The exterior body 50 internally stores the power generation element 40. The exterior body 50 prevents moisture or the like from entering the interior from outside. The exterior body 50 includes, for example, a metal foil 52 and a resin layer 54 laminated on each surface of the metal foil 52, as shown in FIG. 4. The exterior body 50 is a metal laminated film obtained by coating both sides of the metal foil 52 with the resin layer 54.

The metal foil 52 is, for example, aluminum foil or stainless steel foil. A resin film such as polypropylene can be used as the resin layer 54, for example. The material constituting the resin layer 54 may be different between the inner and outer resin layers.

For example, polymers such as polyethylene terephthalate (PET) and polyamide (PA) having a high melting point can be used as the outer material, and polyethylene (PE), polypropylene (PP), and the like can be used as the inner material.

### <Terminals>

Terminals 60 and 62 are respectively connected to the positive electrode 20 and the negative electrode 30. The terminal 60 connected to the positive electrode 20 is a positive electrode terminal, and the terminal 62 connected to the negative electrode 30 is a negative electrode terminal. The terminals 60 and 62 are responsible for electrical connection with outside. The terminals 60 and 62 are made of conductive materials such as aluminum, nickel, and copper. The connection method may be welding or screwing. The terminals 60 and 62 are preferably protected by insulating tape to prevent a short circuit.

### [Method for Manufacturing Solid Electrolyte Battery]

Next, a method for manufacturing a solid electrolyte battery according to the present embodiment will be described. First, a solid electrolyte is prepared. A solid electrolyte can be produced through, for example, a method of mixing raw material powders, which contain predetermined elements at predetermined molar ratios, with each other to cause a mechanochemical reaction. The mechanochemical reaction is adjusted so that unreacted raw materials remain in the solid electrolyte. Specifically, by changing the number of rotations and the number of revolutions of a planetary ball mill, the synthesis time, the states of raw material powders at the time of feeding, unreacted components of the raw materials can be remained.

If a halide raw material is contained in a raw material powder, the halide raw material is likely to evaporate when the temperature is raised. For this reason, halogen gas may be made to coexist in an atmosphere during sintering to supplement halogen. In addition, if the halide raw material is contained in a raw material powder, sintering may be performed through a hot pressing method using a mold with high sealability. In this case, because of the high sealability of the mold, evaporation of the halide raw material due to sintering can be suppressed. Sintering in this manner produces a solid electrolyte in the form of a sintered body consisting of a compound having a predetermined composition.

Subsequently, the positive electrode 20 is prepared. A positive electrode is manufactured by applying a paste containing a positive electrode active material on the positive electrode current collector 22 and drying it to form the positive electrode mixture layer 24. The solid electrolyte described above may be added to the paste containing the positive electrode active material.

Subsequently, the negative electrode 30 is prepared. A negative electrode is manufactured by applying a paste containing a negative electrode active material on the negative electrode current collector 32 and drying it to form the negative electrode mixture layer 34. The solid electrolyte described above may be added to the paste containing the negative electrode active material.

The power generation element 40 can be manufactured, for example, through a powder molding method. A guide with a hole portion is placed over the positive electrode 20 and filled with a solid electrolyte. Thereafter, the surface of the solid electrolyte is smoothed, and the negative electrode 30 is superposed on top of the solid electrolyte. As a result, the solid electrolyte is sandwiched between the positive electrode 20 and the negative electrode 30. Thereafter, the solid electrolyte is then press-molded by applying a pressure to the positive electrode 20 and the negative electrode 30. By performing press-molding, a laminate is obtained in which the positive electrode 20, the solid electrolyte layer 10, and the negative electrode 30 are laminated in this order.

Next, external terminals are respectively welded to the positive electrode current collector 22 of the positive electrode 20 and the negative electrode current collector 32 of the negative electrode 30, which form the laminate, through a well-known method to electrically connect the positive electrode current collector 22 or the negative electrode current collector 32 to each external terminal. Thereafter, the laminate connected to the external terminals is stored in the exterior body 50, and an opening portion of the exterior body 50 is sealed through heat-sealing. A solid electrolyte battery 100 of the present embodiment is obtained through the above-described process.

The solid electrolyte battery 100 according to the present embodiment contains the solid electrolyte described above, resulting in smooth conduction of Li ions and low internal resistance.

The embodiment of the present invention has been described in detail above with reference to the drawings. However, each configuration and combination of each embodiment is merely an example, and addition, omission, replacement, and other modifications of the configuration can be made within the scope not departing from the gist of the present invention.

### EXAMPLES

### Example 1

### (Production of Solid Electrolyte)

In a glove box with a dew point of about −75° C., raw material powders were weighed out so that the molar ratio of zirconium chloride (ZrCl₄) and lithium sulfate (Li₂SO₄) was 1:8. First, Li₂SO₄ before mixing was ground for 1 hour using a planetary ball mill. The rotational frequency during grinding was 300 rpm. Subsequently, the raw material powders were placed in a sealed zirconia container for a planetary ball mill in which zirconia balls had been placed in advance. Next, the sealed container was covered with a lid, the lid was screwed onto the container body, and the space between the lid and the container was further sealed with polyimide tape. The polyimide tape is effective in blocking moisture. Next, the sealed zirconia container was set in the planetary ball mill. The number of rotations was set to 200 rpm, the number of revolutions was set to 200 rpm, the raw material powders were mixed together with the rotation direction and the revolution direction in opposite directions to cause a mechanochemical reaction for 2 hours to produce a solid electrolyte (Li₄Zr_{0.25}(SO₄)₂Cl).

Planetary ball mills are usually installed in an atmosphere (atmospheric air). The sealed zirconia container for a planetary ball mill is screwed and sealed with polyimide tape, and when the sealed zirconia container is set in the planetary ball mill, it is firmly pressed and fixed. Therefore, even in a normal atmosphere, it is thought that there is almost no moisture contamination from atmospheric air in the sealed zirconia container.

### [XRD Measurement]

A holder for XRD measurement was filled with the produced solid electrolyte in a glove box with a dew point of about −70° C. with argon gas circulating. Thereafter, polyimide tape (vacuum-dried at 70° C. for 16 hours) was attached to the holder for XRD measurement to cover and seal the filling surface to prevent moisture, and an XRD measurement sample was prepared. Subsequently, the XRD measurement sample was taken out into atmospheric air and subjected to XRD measurement using an X-ray diffractometer (manufactured by PANalytical, X'Pert Pro). Cu-Kα ray (measurement wavelength=0.799407 Å) was used as an X-ray source.

In addition, only the polyimide tape used to prevent moisture was attached to the holder for XRD measurement, and background measurement was performed under the same conditions as those of the above-described XRD measurement. A X-ray diffraction pattern of the produced solid electrolyte had peaks at a diffraction angle 2θ=22.3°±1.0° and a diffraction angle 2θ=36.4°±1.0°.

### [XPS Measurement]

In addition, X-ray photoelectron spectroscopy measurement was performed. Sampling was performed in a glove box with a dew point of about −70° C. with argon gas circulating, and the sample was transported to an XPS measurement device under non-exposure to the atmosphere. Quantera 2 manufactured by PHI was used for the XPS measurement. As a result, peaks at 170±0.5 eV and 532±0.5 eV were observed in the produced solid electrolyte.

### [Measurement of Ionic Conductivity]

Subsequently, in a glove box with a dew point of about −70° C. with argon gas circulating, the obtained solid electrolyte powder was filled into a press-molding die and press-molded with a weight of about 30 KN to manufacture a ionic conductivity measurement cell.

The press-molding die consists of a polyether ether ketone (PEEK) cylinder with a diameter of 10 mm and upper and lower punches which have a diameter of 9.99 mm and are made of SKD11 material.

Thereafter, a stainless-steel disk and a Teflon (registered trademark) disk with a diameter of 50 mm, a thickness of 5 mm, and screw holes in four locations were prepared to set a press-molding die as follows. A stainless-steel disk, a Teflon (registered trademark) disk, a press-molded die, a Teflon (registered trademark) disk, and a stainless-steel disk were stacked in this order, and four screws were tightened with a torque of about 3 Nm. In addition, screws were inserted into the screw holes provided on the side surfaces of the upper and lower punches to serve as external connection terminals.

The external connection terminals were connected to a potentiostat (VersaSTAT3 manufactured by Princeton Applied Research) equipped with a frequency response analyzer to measure ionic conductivity using an impedance measurement method. Measurement was performed in a measurement frequency range of 1 MHz to 0.1 Hz, an amplitude of 10 mV, and a temperature of 25° C. The ionic conductivity of the solid electrolyte of Example 1 was 1.1×10⁻³ S/cm.

### Examples 2 to 8

Examples 2 to 8 differ from Example 1 in that materials and molar ratios of raw material powders were changed. The solid electrolytes were also subjected to measurement in Examples 2 to 8 in the same manner as in Example 1. The configuration, molar ratio, and measurement results of each raw material were listed in Table 1 below.

### Examples 9 to 21

Examples 9 to 21 differ from Example 1 in that materials and molar ratios of raw material powders were changed and the manufacturing conditions of the solid electrolytes were changed. The solid electrolytes were also subjected to measurement in Examples 9 to 21 in the same manner as in Example 1.

Examples 9 to 21 were produced according to the following procedure. First, zirconium chloride (ZrCl₄), lithium sulfate (Li₂SO₄), and other raw materials were each weighed out to a predetermined molar ratio in a glove box with a dew point of about −75° C. Subsequently, Li₂SO₄ before mixing was pulverized using a planetary ball mill at a rotation frequency of 300 rpm for 1 hour, and then, ZrCl₄ was added thereto and the mixture was further pulverized at a rotation frequency of 200 rpm for 1 hour. Subsequently, the pulverized sample and other raw materials were placed in a sealed zirconia container for a planetary ball mill in which zirconia balls had been placed in advance. Then, the number of rotations was set to 200 rpm, the number of revolutions was set to 200 rpm, and the rotation direction and the revolution direction were set in opposite directions to cause a mechanochemical reaction for a predetermined period of time to produce a desired solid electrolyte.

The solid electrolytes were also subjected to measurement in Examples 9 to 21 in the same manner as in Example 1. The configuration, molar ratio, and measurement results of each raw material were listed in Table 1 below.

### Examples 22 to 25

Examples 22 to 25 differ from Example 1 in that materials and molar ratios of raw material powders were changed and the manufacturing conditions of the solid electrolytes were changed. The solid electrolytes were also subjected to measurement in Examples 22 to 25 in the same manner as in Example 1.

Examples 22 to 25 were produced according to the following procedure. First, in a glove box with a dew point of −75° C., Li₂O, ZrCl₄, and Li₂SO₄ were each weighed out to a predetermined molar ratio. First, Li₂SO₄ was pulverized at a rotation frequency of 200 rpm for 1 hour before mixing. Subsequently, Li₂O and ZrCl₄ were mixed together at a rotation frequency of 300 rpm for 48 hours, and then Li₂SO₄ was added thereto to cause a mechanochemical reaction for a predetermined period of time to produce a desired solid electrolyte.

The solid electrolytes were also subjected to measurement in Examples 22 to 25 in the same manner as in Example 1. The configuration, molar ratio, and measurement results of each raw material were listed in Table 2 below.

### Example 26

Example 26 differs from Example 1 in that materials and molar ratios of raw material powders were changed and the manufacturing conditions of the solid electrolyte were changed. The solid electrolyte was also subjected to measurement in Example 26 in the same manner as in Example 1.

First, in a glove box with a dew point of −75° C., Li₃PO₄, ZrCl₄, and Li₂SO₄ were each weighed out to a predetermined molar ratio. First, Li₂SO₄ was pulverized at a rotation frequency of 200 rpm for 1 hour before mixing. Subsequently, Li₃PO₄ and ZrCl₄ were mixed together at a rotation frequency of 300 rpm for 24 hours, and then Li₂SO₄ was added thereto to cause a mechanochemical reaction for a predetermined period of time to produce a desired solid electrolyte.

The solid electrolyte was also subjected to measurement in Example 26 in the same manner as in Example 1. The configuration, molar ratio, and measurement results of each raw material were listed in Table 2 below.

### Examples 27 to 29

Examples 27 to 29 differ from Example 1 in that materials and molar ratios of raw material powders were changed and the manufacturing conditions of the solid electrolytes were changed. The solid electrolytes were also subjected to measurement in Examples 27 to 29 in the same manner as in Example 1.

First, Li₂O and LiX were mixed together at a molar ratio of 2:1 in a glove box with a dew point of −75° C. Mixing was performed using the planetary ball mill described above at a rotation frequency of 300 rpm for 48 hours. Subsequently, LZSOC synthesized in Example 4 was added thereto to cause a mechanochemical reaction at a rotation frequency of 200 rpm for a predetermined period of time to produce a desired solid electrolyte.

The solid electrolytes were also subjected to measurement in Examples 27 to 29 in the same manner as in Example 1. The configuration, molar ratio, and measurement results of each raw material were listed in Table 2 below.

### Examples 30 and 31

Examples 30 and 31 differ from Example 4 in the dew point of a dry room during mixing. The dew point for Example 30 was set to −40° C. and the dew point for Example 31 was set to −60° C. For other conditions, the solid electrolytes were subjected to measurement in the same manner as in Example 4. The configuration, molar ratio, and measurement results of each raw material were listed in Table 2 below.

### Examples 32 to 34

Examples 32 to 34 differ from Example 1 in that materials and molar ratios of raw material powders were changed and the manufacturing conditions of the solid electrolytes were changed. The solid electrolytes were also subjected to measurement in Examples 32 to 34 in the same manner as in Example 1.

First, ZrCl₄ and LiX were mixed together at a predetermined molar ratio in a glove box with a dew point of −75° C. Mixing was performed using the planetary ball mill described above at a rotation frequency of 300 rpm for 24 hours. Subsequently, LZSOC synthesized in Example 4 was added thereto to cause a mechanochemical reaction at a rotation frequency of 200 rpm for a predetermined period of time to produce a desired solid electrolyte.

The solid electrolytes were also subjected to measurement in Examples 32 to 34 in the same manner as in Example 1. The configuration, molar ratio, and measurement results of each raw material were listed in Tables 3 and 4 below.

### Examples 35 to 45

Examples 35 to 45 differ from Example 1 in that materials and molar ratios of raw material powders were changed and the manufacturing conditions of the solid electrolytes were changed. The solid electrolytes were also subjected to measurement in Examples 35 to 45 in the same manner as in Example 1.

First, ZrCl₄, LiCl, and LiX were mixed together at a predetermined molar ratio in a glove box with a dew point of −75° C. Mixing was performed using the planetary ball mill described above at a rotation frequency of 300 rpm for 24 hours. Subsequently, LZSOC synthesized in Example 4 was added thereto to cause a mechanochemical reaction at a rotation frequency of 200 rpm for a predetermined period of time to produce a desired solid electrolyte.

The solid electrolytes were also subjected to measurement in Examples 35 to 45 in the same manner as in Example 1. The configuration, molar ratio, and measurement results of each raw material were listed in Tables 3 and 4 below.

### Comparative Examples 1 to 11

Comparative Examples 1 to 11 differ from Example 1 in that materials and molar ratios of raw material powders were changed and the manufacturing conditions of the solid electrolytes were changed. The solid electrolytes were also subjected to measurement in Comparative Examples 1 to 11 in the same manner as in Example 1.

A method for producing solid electrolytes according to Comparative Examples 1 to 11 differs from the method for producing the solid electrolyte according to Example 1 in reaction time of a mechanochemical reaction (mixing time of raw material powders) and in that the number of rotations and the number of revolutions of a planetary ball mill during the mechanochemical reaction are 300 rpm and Li₂SO₄ is used without being pulverized before mixing.

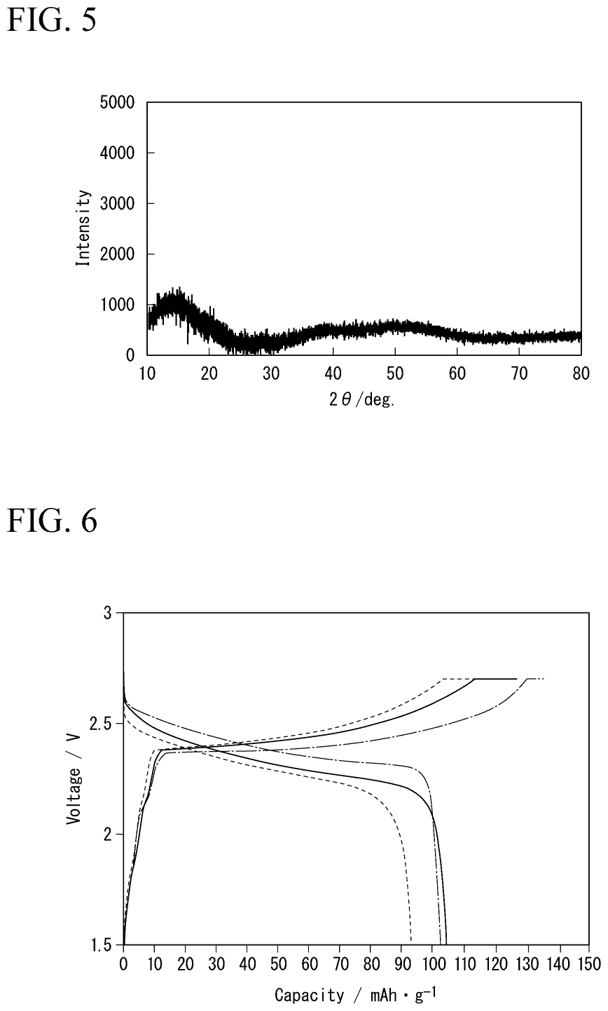

The solid electrolytes were also subjected to measurement in Comparative Examples 1 to 11 in the same manner as in Example 1. The configuration, molar ratio, and measurement results of each raw material were listed in Table 2 below. In addition, FIG. 5 shows X-ray diffraction results of Comparative Example 4. In Comparative Example 4, no peaks were observed at a diffraction angle 2θ=22.3°±1.0° and a diffraction angle 2θ=36.4°±1.0°. The X-ray diffraction pattern shown in FIG. 5 is one obtained by removing background data of polyimide tape from the measurement results.

### Comparative Example 12

Example 12 differs from Example 4 in the dew point of a dry room during mixing. The dew point in Comparative Example 12 was set at −20° C. For other conditions, the solid electrolytes were subjected to measurement in the same manner as in Example 4. The configuration, molar ratio, and measurement results of each raw material were listed in Table 2 below.

TABLE 1

| | Raw material | | | Molar ratio | | |
|---|---|---|---|---|---|---|
| | Sub- | Sub- | Sub- | Sub- | Sub- | Sub- |
| | stance A | stance B | stance C | stance A | stance B | stance C |
| Example 1 | Li₂SO₄ | ZrCl₄ | | 8 | 1 | |
| Example 2 | Li₂SO₄ | ZrCl₄ | | 6 | 1 | |
| Example 3 | Li₂SO₄ | ZrCl₄ | | 2 | 1 | |
| Example 4 | Li₂SO₄ | ZrCl₄ | | 1 | 1 | |
| Example 5 | Li₂SO₄ | ZrCl₄ | | 1 | 2 | |
| Example 6 | Li₂SO₄ | ZrCl₄ | | 1 | 4 | |
| Example 7 | Zr(SO₄)₂ | Li₂SO₄ | LiCl | 1 | 0.1 | 1 |
| Example 8 | Zr(SO₄)₂ | Li₂SO₄ | LiCl | 1 | 0.05 | 0.5 |
| Example 9 | Zr(SO₄)₂ | Li₂SO₄ | ZrCl₄ | 0.5 | 1 | 1 |
| Example 10 | Zr(SO₄)₂ | Li₂SO₄ | ZrCl₄ | 0.4 | 1 | 1.5 |
| Example 11 | Li₂SO₄ | NaSO₄ | ZrCl₄ | 0.6 | 0.4 | 1 |
| Example 12 | Li₂SO₄ | KSO₄ | ZrCl₄ | 0.7 | 0.3 | 1 |
| Example 13 | Li₂SO₄ | RbSO₄ | ZrCl₄ | 0.8 | 0.2 | 1 |
| Example 14 | Li₂SO₄ | CsSO₄ | ZrCl₄ | 0.9 | 0.1 | 1 |
| Example 15 | Li₂SO₄ | AlCl₃ | ZrCl₄ | 1 | 0.2 | 0.8 |
| Example 16 | Li₂SO₄ | GaCl₃ | ZrCl₄ | 1 | 0.2 | 0.8 |
| Example 17 | Li₂SO₄ | InCl₃ | ZrCl₄ | 1 | 0.2 | 0.8 |
| Example 18 | Li₂SO₄ | ScCl₃ | ZrCl₄ | 1 | 0.2 | 0.8 |
| Example 19 | Li₂SO₄ | YCl₃ | ZrCl₄ | 1 | 0.2 | 0.8 |
| Example 20 | Li₂SO₄ | TiCl₄ | ZrCl₄ | 1 | 0.2 | 0.8 |
| Example 21 | Li₂SO₄ | HfCl₄ | ZrCl₄ | 1 | 0.1 | 0.9 |
| | | | XRD | | Li ionic | Rate |
| | Mixing | | 22.3° ± | 36.4° ± | conductivity | characteristics |
| | time | Solid electrolyte | 1.0° | 1.0° | (S/cm) | (1 C/0.1 C) |
| Example 1 | 2 | Li₄Zr_{0.25}(SO₄)₂Cl | A | A | 1.1E−03 | 61 |
| Example 2 | 3 | Li₆Zr_{0.5}(SO₄)₃Cl₂ | A | A | 1.3E−03 | 63 |
| Example 3 | 4 | Li₄Zr(SO₄)₂Cl₄ | A | A | 1.5E−03 | 64 |
| Example 4 | 5 | Li₂Zr(SO₄)Cl₄ | A | A | 2.4E−03 | 75 |
| Example 5 | 6 | LiZr(SO₄)_{0.5}Cl₄ | A | B | 2.0E−03 | 73 |
| Example 6 | 7 | Li_{0.5}Zr(SO₄)_{0.25}Cl₄ | A | B | 1.5E−03 | 65 |
| Example 7 | 8 | Li_{1.2}Zr(SO₄)_{2.1}Cl | A | B | 1.0E−03 | 61 |
| Example 8 | 8 | Li_{0.6}Zr(SO₄)_{0.25}Cl_{0.5} | A | B | 1.0E−03 | 60 |
| Example 9 | 5 | Li₂Zr_{1.5}(SO₄)₂Cl₄ | A | B | 1.2E−03 | 62 |
| Example 10 | 5 | Li₂Zr_{1.9}(SO₄)_{1.8}Cl₆ | A | A | 1.2E−03 | 61 |
| Example 11 | 5 | LiNaZr(SO₄)₂Cl₄ | A | B | 1.8E−03 | 70 |
| Example 12 | 5 | LiKZr(SO₄)₂Cl₄ | A | A | 1.5E−03 | 67 |
| Example 13 | 5 | LiRbZr(SO₄)₂Cl₄ | A | A | 1.4E−03 | 67 |
| Example 14 | 5 | LiCsZr(SO₄)₂Cl₄ | A | A | 1.2E−03 | 62 |
| Example 15 | 5 | Li₂Zr_{0.8}Al_{0.2}(SO₄)Cl_{3.8} | A | B | 2.2E−03 | 73 |
| Example 16 | 5 | Li₂Zr_{0.8}Ga_{0.2}(SO₄)Cl_{3.8} | A | B | 2.2E−03 | 72 |
| Example 17 | 5 | Li₂Zr_{0.8}In_{0.2}(SO₄)Cl_{3.8} | A | B | 2.5E−03 | 77 |
| Example 18 | 5 | Li₂Zr_{0.8}Sc_{0.2}(SO₄)Cl_{3.8} | A | B | 2.7E−03 | 80 |
| Example 19 | 5 | Li₂Zr_{0.8}Y_{0.2}(SO₄)Cl_{3.8} | A | B | 1.5E−03 | 66 |
| Example 20 | 5 | Li₂Zr_{0.8}Y_{0.2}(SO₄)Cl₄ | A | B | 1.4E−03 | 64 |
| Example 21 | 5 | Li₂Zr_{0.9}Hf_{0.1}(SO₄)Cl₄ | A | B | 2.1E−03 | 73 |

TABLE 2

| | Raw material | | | Molar ratio | | |
|---|---|---|---|---|---|---|
| | Sub- | Sub- | Sub- | Sub- | Sub- | Sub- |
| | stance A | stance B | stance C | stance A | stance B | stance C |
| Example 22 | LZOC | Li₂SO₄ | | 1 | 2 | |
| Example 23 | LZOC | Li₂SO₄ | | 1 | 1 | |
| Example 24 | LZOC | Li₂SO₄ | | 1 | 0.5 | |
| Example 25 | LZOC | Li₂SO₄ | | 1 | 0.1 | |
| Example 26 | LZPOC | Li₂SO₄ | | 1 | 1 | |
| Example 27 | Li₃O₂I | LZSOC | | 0.5 | 1 | |
| Example 28 | Li₃O₂Br | LZSOC | | 0.5 | 1 | |
| Example 29 | Li₃O₂F | LZSOC | | 0.5 | 1 | |
| Example 30 | H₂O | LZSOC | | 0.1 | 1 | |
| Example 31 | H₂O | LZSOC | | 0.025 | 1 | |
| Comparative Example 1 | Li₂SO₄ | ZrCl₄ | | 8 | 1 | |
| Comparative Example 2 | Li₂SO₄ | ZrCl₄ | | 6 | 1 | |
| Comparative Example 3 | Li₂SO₄ | ZrCl₄ | | 2 | 1 | |
| Comparative Example 4 | Li₂SO₄ | ZrCl₄ | | 1 | 1 | |
| Comparative Example 5 | Li₂SO₄ | ZrCl₄ | | 1 | 2 | |
| Comparative Example 6 | Li₂SO₄ | ZrCl₄ | | 1 | 4 | |
| Comparative Example 7 | Li₂SO₄ | ZrCl₄ | | 16 | 1 | |
| Comparative Example 8 | Li₂SO₄ | Na₂SO₄ | ZrCl₄ | 4 | 4 | 1 |
| Comparative Example 9 | AlCl₃ | Li₂SO₄ | ZrCl₄ | 1.5 | 1 | 1 |
| Comparative Example 10 | Zr(SO₄)₂ | LiBF₄ | | 1 | 7 | |
| Comparative Example 11 | Li₂SO₄ | Zr(SO₄)₂ | ZrCl₄ | 1 | 3 | 1 |
| Comparative Example 12 | H₂O | LZSOC | | 0.25 | 1 | |
| | | | XRD | | Li ionic | Rate |
| | Mixing | | 22.3° ± | 36.4° ± | conductivity | characteristics |
| | time | Solid electrolyte | 1.00° | 1.0° | (S/cm) | (1 C/0.1 C) |
| Example 22 | 0.5 | Li₅Zr(SO₄)₂OCl₄ | A | B | 1.2E−03 | 63 |
| Example 23 | 0.5 | Li₄Zr(SO₄)OCl₄ | A | B | 1.7E−03 | 68 |
| Example 24 | 0.5 | Li₃Zr(SO₄)_{0.5}OCl₄ | A | B | 2.3E−03 | 74 |
| Example 25 | 0.5 | Li_{2.2}Zr(SO₄)_{0.1}OCl₄ | A | B | 2.8E−03 | 80 |
| Example 26 | 0.5 | Li_{2.5}Zr(SO₄)_{0.5}(PO₄)_{0.5}Cl₄ | A | B | 2.5E−03 | 78 |
| Example 27 | 0.2 | Li_{4.5}Zr(SO₄)OCl₄I_{0.5} | A | B | 2.1E−03 | 73 |
| Example 28 | 0.2 | Li_{4.5}Zr(SO₄)OCl₄Br_{0.5} | A | B | 2.3E−03 | 75 |
| Example 29 | 0.2 | Li_{4.5}Zr(SO₄)OCl₄F_{0.5} | A | B | 1.8E−03 | 70 |
| Example 30 | 5 | Li₂Zr(SO₄)O_{0.1}Cl₄H_{0.2} | A | B | 1.2E−03 | 62 |
| Example 31 | 5 | Li₂Zr(SO₄)O_{0.025}Cl₄H_{0.05} | A | B | 2.2E−03 | 74 |
| Comparative Example 1 | 2 | Li₄Zr_{0.25}(SO₄)₂Cl | B | B | 1.2E−05 | 3 |
| Comparative Example 2 | 3 | Li₆Zr_{0.5}(SO₄)₃Cl₂ | B | B | 3.3E−05 | 8 |
| Comparative Example 3 | 4 | Li₄Zr(SO₄)₂Cl₄ | B | B | 1.9E−04 | 30 |
| Comparative Example 4 | 5 | Li₂Zr(SO₄)Cl₄ | B | B | 4.0E−04 | 40 |
| Comparative Example 5 | 6 | LiZr(SO₄)_{0.5}Cl₄ | B | B | 5.5E−04 | 42 |
| Comparative Example 6 | 7 | Li_{0.5}Zr(SO₄)_{0.25}Cl₄ | B | B | 7.8E−04 | 50 |
| Comparative Example 7 | 1 | Li₈Zr_{0.25}(SO₄)₄Cl | A | A | 3.4E−05 | 8 |
| Comparative Example 8 | 3 | LiNa₇Zr_{0.25}(SO₄)₄Cl | A | A | 6.2E−05 | 14 |
| Comparative Example 9 | 5 | Li₂ZrAl_{1.5}(SO₄)Cl_{8.5} | A | A | 2.8E−04 | 34 |
| Comparative Example 10 | 7 | Li₇Zr(SO₄)₂(BF₄)₇Cl₄ | B | B | 9.4E−05 | 25 |
| Comparative Example 11 | 5 | Li₂Zr₄(SO₄)₇Cl₄ | A | A | 7.8E−05 | 22 |
| Comparative Example 12 | 5 | Li₂Zr(SO₄)Cl₄ | A | B | 8.5E−04 | 54 |

TABLE 3

| | Raw material | | | | Molar ratio | | | | | |
|---|---|---|---|---|---|---|---|---|---|---|
| | Sub- | Sub- | Substance | Substance | Sub- | Sub- | Sub- | Sub- | Mixing | |
| | stance A | stance B | C | D | stance A | stance B | stance C | stance D | time | Solid electrolyte |
| Example 32 | LZSOC | ZrCl₄ | LiBO₂ | | 1 | 1 | 2 | | 1 | Li₂Zr(SO₄)_{0.5}(BO₂)Cl₄ |
| Example 33 | LZSOC | ZrCl₄ | Li₂CO₃ | | 1 | 1 | 1 | | 1 | Li₂Zr(SO₄)_{0.5}(CO₃)_{0.5}Cl₄ |
| Example 34 | LZSOC | ZrCl₄ | Li₂SiO₃ | | 1 | 1 | 1 | | 1 | Li₂Zr(SO₄)_{0.5}(SiO₃)_{0.5}Cl₄ |
| Example 35 | LZSOC | ZrCl₄ | LiCl | LiOH | 1 | 1 | 1 | 1 | 4 | Li₂Zr(SO₄)_{0.5}(OH)_{0.5}Cl_{4.5} |
| Example 36 | LZSOC | ZrCl₄ | LiCl | LiBF₄ | 1 | 1 | 1.5 | 0.5 | 0.5 | Li₂Zr(SO₄)_{0.5}(BF₄)_{0.25}Cl_{4.75} |
| Example 37 | LZSOC | ZrCl₄ | LiCl | LiPF₆ | 1 | 1 | 1.9 | 0.1 | 0.5 | Li₂Zr(SO₄)_{0.5}(PF₆)_{0.05}Cl_{4.95} |
| Example 38 | LZSOC | ZrCl₄ | LiCl | Li(BOB) | 1 | 1 | 1.9 | 0.1 | 0.5 | Li₂Zr(SO₄)_{0.5}(BOB)_{0.05}Cl_{4.95} |
| Example 39 | LZSOC | ZrCl₄ | LiCl | HCOOLi | 1 | 1 | 1.5 | 0.5 | 1 | Li₂Zr(SO₄)_{0.5}(HCOO)_{0.25}Cl_{4.75} |
| Example 40 | LZSOC | ZrCl₄ | LiCl | (COOLi)₂ | 1 | 1 | 1 | 0.5 | 2 | Li₂Zr(SO₄)_{0.5}((COO)₂)_{0.25}Cl_{4.5} |
| Example 41 | LZSOC | ZrCl₄ | LiCl | Li₃N | 1 | 1 | 1 | 0.334 | 2 | Li₂Zr(SO₄)_{0.5}N_{0.167}Cl_{4.5} |
| Example 42 | LZSOC | ZrCl₄ | LiCl | LiAlCl₄ | 1 | 1 | 1 | 1 | 2 | Li₂Zr(SO₄)_{0.5}(AlCl₄)_{0.5}Cl_{4.5} |
| Example 43 | LZSOC | ZrCl₄ | LiCl | CF₃SO₃Li | 1 | 1 | 1.9 | 0.1 | 0.5 | Li₂Zr(CF₃SO₃)_{0.05}Cl_{4.95} |
| Example 44 | LZSOC | ZrCl₄ | LiCl | CH₃COOLi | 1 | 1 | 1.5 | 0.5 | 1 | Li₂Zr(SO₄)_{0.5}(CH₃COO)_{0.25}Cl_{4.5} |
| Example 45 | LZSOC | ZrCl₄ | LiCl | CH₃COOLi | 1 | 1 | 1.5 | 0.5 | 1 | Li₂Zr(SO₄)_{0.5}(CH₃COO)_{0.25}Cl_{4.5} |

TABLE 4

| | | | Li ionic | Rate |
|---|---|---|---|---|
| | XRD | | conductivity | characteristics |
| | 22.3° ± 1.0° | 36.4° ± 1.0° | (S/cm) | (1 C/0.1 C) |
| Example 32 | A | B | 1.7E−03 | 69 |
| Example 33 | A | B | 1.8E−03 | 71 |
| Example 34 | A | B | 1.9E−03 | 71 |
| Example 35 | A | B | 2.2E−03 | 73 |
| Example 36 | A | B | 1.4E−03 | 66 |
| Example 37 | A | B | 1.2E−03 | 63 |
| Example 38 | A | B | 1.1E−03 | 61 |
| Example 39 | A | B | 1.5E−03 | 68 |
| Example 40 | A | B | 1.7E−03 | 70 |
| Example 41 | A | B | 1.9E−03 | 72 |
| Example 42 | A | B | 1.2E−03 | 64 |
| Example 43 | A | B | 1.4E−03 | 67 |
| Example 44 | A | B | 1.3E−03 | 65 |
| Example 45 | A | B | 1.3E−03 | 66 |

In Tables 1 and 2 described above, LZOC is a mixture of Li₂O and ZrCl₄. LZSOC is a mixture of Li₂SO₄ and ZrCl₄. LZPOC is a mixture of Li₃PO₄ and ZrCl₄. “A” in the XRD column indicates that the peak was observed, and “B” indicates that no peak was observed. In the XPS analysis, peaks at 170±0.5 eV and 532±0.5 eV in both the examples and the comparative examples were observed.

(Manufacture of all-Solid Battery)

An all-solid battery was also manufactured in a glove box with a dew point of about −70° C. The all-solid battery was manufactured using a pellet making tool. The pellet making tool has a polyether ether ketone (PEEK) holder with a diameter of 10 mm and an upper punch and a lower punch which have a diameter of 9.99 mm. The material of the upper and lower punches is die steel (SKD11 material).

The lower punch was inserted into the PEEK holder of the pellet making tool, and 50 mg of a solid electrolyte was placed on top of the lower punch. Subsequently, the resin holder was vibrated to smooth the surface of the solid electrolyte, and then, the upper punch was inserted on the solid electrolyte and pressed with a weight of about 4 KN using a press.

Next, the lower punch was pulled out and 10 mg of a negative electrode mixture was placed on top of the solid electrolyte. Subsequently, the PEEK holder was vibrated to smooth the surface of the negative electrode mixture, and then, the lower punch was inserted on the negative electrode mixture and pressed with a weight of about 3 KN using a press. The negative electrode mixture consists of a negative electrode active material and the above-described solid electrolyte, and the negative electrode active material used was lithium titanate (LTO) with an average particle diameter of 6.0 μm. Next, the upper punch was removed, and 10 mg of a positive electrode mixture was placed on top of the solid electrolyte layer. Subsequently, the PEEK holder was vibrated to smooth the surface of the positive electrode mixture, and then, the upper punch was inserted on the positive electrode mixture and pressed with a weight of about 3 KN using a press. The positive electrode mixture consists of a positive electrode active material, carbon as a conductive assistant, and the above-described solid electrolyte, and the positive electrode active material used was lithium cobaltate (LCo) with an average particle diameter of 7.5 μm. In this manner, an all-solid-state battery was manufactured in which the negative electrode mixture layer, the solid electrolyte layer, and the positive electrode mixture layer were stacked in this order.

In addition, two stainless steel plates with a diameter of 50 mm and a thickness of 5 mm and two Bakelite (registered trademark) sheets with a diameter of 50 mm and a thickness of 2 mm were prepared. Subsequently, four holes for screws were made in each of the two stainless steel plates and two Bakelite (registered trademark) plates. The holes for screws were located where, when an electrochemical cell, the two stainless steel plates, and the two Bakelite (registered trademark) plates were stacked, the two stainless steel plates and the two Bakelite (registered trademark) plates overlapped in a plan view but did not overlap with the electrochemical cell in a plan view.

Thereafter, a stainless-steel plate, a Bakelite (registered trademark) plate, the all-solid battery, a Bakelite (registered trademark) plate, and a stainless steel plate were then stacked in this order, and screws were inserted into the screw holes described above and tightened with a torque of 1 Nm. In this manner, an all-solid battery was obtained in which the upper and lower punches of the electrochemical cell were insulated by the Bakelite (registered trademark) plates. Next, the all-solid battery was allowed to stand in a thermostatic bath at 25° C. for 48 hours to stabilize open-circuit voltage.

Rate characteristics were evaluated using the manufactured all-solid battery. The rate characteristics were evaluated from the ratio of discharge capacity when discharged at a discharge rate of 1 C to discharge capacity at a discharge rate of 0.1C (1 C/0.1 C rate characteristics). Constant current charging (CC charging) was performed in an environment of 25° C. at a constant current rate of 0.1 C until the battery voltage reached 2.7 V, and after reaching 2.7 V, the all-solid battery was charged until a current equivalent to 0.05 C was reached (CV charging). Thereafter, the all-solid battery was discharged at a constant current rate of 0.1 C until the battery voltage reached 1.5 V (CC discharging), and the discharge capacity at 0.1 C was measured. Subsequently, the all-solid battery was then charged again under the above-described conditions and discharged at a discharge rate of 1 C until the battery voltage reached 1.5 V, and the discharge capacity at 1 C was measured. The measurement results thereof are also summarized in Tables 1, 2, 3, and 4.

In addition, FIG. 6 shows charge/discharge curves of Example 4 and Comparative Examples 3 and 4. Example 4 is indicated by alternate long and short dash lines, Comparative Example 3 is indicated by dotted lines, and Comparative Example 4 is indicated by solid lines. As shown in FIG. 6, higher input/output characteristics were observed in Example 4 than in Comparative Examples 3 and 4.

### INDUSTRIAL APPLICABILITY

According to the present invention, a solid electrolyte with improved ionic conductivity can be obtained.

### REFERENCE SIGNS LIST

10 Solid electrolyte layer
20 Positive electrode
22 Positive electrode current collector
24 Positive electrode mixture layer
30 Negative electrode
32 Negative electrode current collector
34 Negative electrode mixture layer
40 Power generation element
50 Exterior body
52 Metal foil
54 Resin layer
60, 62 Terminal
100 Solid electrolyte battery

1. A solid electrolyte comprising:
LiₐA_{b}E_{c}(SO₄)_{d}JₑX_{f}Hₕ (1),
wherein, in Formula (1),
A is at least one element selected from alkaline earth metals and alkali metals other than Li,
E is at least one element selected from the group consisting of Al, Ga, In, Sc, Y, Ti, Zr, Hf, and lanthanides,
J is at least one group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₅, S₂O₃, S₂O₄, S₂O₅, S₂O₆, S₂O₇, S₂₀₈, BF₄, PF₆, BOB, (COO)₂, N, AlCl₄, CF₃SO₃, CH₃COO, CF₃COO, OOC—(CH₂)₂-COO, OOC—CH₂—COO, OOC—CH(OH)—CH(OH)—COO, OOC—CH(OH)—CH₂—COO, C₆H₅SO₃, OOC—CH═CH—COO, OOC—CH═CH—COO,C(OH)(CH₂COOH)₂COO, AsO₄, BiO₄, CrO₄, MnO₄, PtF₆, PtCl₆, PtBr₆, PtI₆, SbO₄, SeO₄, TeO₄, HCOO, and O,
X is at least one element selected from the group consisting of F, Cl, Br, and I,
0.5≤a<6, 0≤b<6, 0<c<2, 0.1<d≤6.0, 0<e≤6.0, 0<f≤6.1, and 0≤h≤0.2 are satisfied, and
a peak is observed at a diffraction angle 2θ=22.3≅+1.0° in an X-ray diffraction pattern in which Cu-Kα is used as a line source.

2. The solid electrolyte according to claim 1,
wherein, a peak is observed at a diffraction angle 2θ=36.4°±1.0° in the X-ray diffraction pattern in which Cu-Kα is used as a line source.

3. The solid electrolyte according to claim 1,
wherein, in X-ray photoelectron spectroscopy measurement, a peak is observed at 170±0.5 eV and 532±0.5 eV.

4. The solid electrolyte according to claim 1,
wherein an ionic conductivity at 25° C. is 1 mS/cm or more.

5. A solid electrolyte layer comprising:
the solid electrolyte according to claim 1.

6. A solid electrolyte battery comprising:
a negative electrode;
a positive electrode; and
a solid electrolyte layer that is between the negative electrode and the positive electrode and contains a solid electrolyte,
wherein at least one or more of the negative electrode, the positive electrode, and the solid electrolyte layer contains the solid electrolyte according to claim 1.

7. A solid electrolyte battery comprising:
a negative electrode;
a positive electrode; and
the solid electrolyte layer according to claim 5 between the negative electrode and the positive electrode.
